(19) United States
(12) Patent Application Publication
(10) Pub. No.: US 2025/0054686 A1
(43) Pub. Date: Feb. 13, 2025

(54) INDUCTOR COMPONENT

(71) Applicant: Murata Manufacturing Co., Ltd., Kyoto-fu (JP)

(72) Inventor: Takeru OZAWA, Nagaokakyo-shi (JP)

(73) Assignee: Murata Manufacturing Co., Ltd., Kyoto-fu (JP)

(21) Appl. No.: 18/788,386

(22) Filed: Jul. 30, 2024

(30) Foreign Application Priority Data
Aug. 8, 2023 (JP) 2023-129274

(51) Int. Cl. H01F 27/29; H01F 27/32

(52) U.S. Cl. CPC H01F 27/292; H01F 27/324

(57) ABSTRACT

An inductor component includes an element body including an insulator; a coil inside the element body; and a first outer electrode electrically connected to the coil. The element body includes first and second end surfaces opposed to each other in a length direction, first and second main surfaces opposed to each other in a height direction perpendicular to the length direction, and first and second side surfaces opposed to each other in a width direction perpendicular to the length and height directions. The first end surface intersects the first main surface on a first ridge line. The second end surface intersects the first main surface on a second ridge line. The first outer electrode includes a first electrode layer embedded in the element body such that at least part of the first electrode layer is exposed from the element body.

### CROSS-REFERENCE TO RELATED APPLICATION

This application claims benefit of priority to Japanese Patent Application No. 2023-129274, filed Aug. 8, 2023, the entire content of which is incorporated herein by reference.

### BACKGROUND

### Technical Field

The present disclosure relates to an inductor component.

### Background Art

Japanese Unexamined Patent Application Publication No. 2013-98356 discloses a laminated inductor that includes a multilayer body having a substantially rectangular parallelepiped shape and including a plurality of laminated insulation layers and a plurality of internal conductor layers laminated with the insulation layers interposed therebetween. The internal conductor layers are connected to have a spiral shape so as to have a coil structure. The coil axis of the coil structure is parallel to the bottom surface of the multilayer body and perpendicular to the direction in which a pair of outer electrodes are opposed to each other. The pair of outer electrodes are formed on end surfaces of the multilayer body that are opposed to each other. Edge portions of sections of the internal conductor layers are rounded.

### SUMMARY

In the method of manufacturing a laminated inductor described in Japanese Unexamined Patent Application Publication No. 2013-98356, insulator sheets on each of which conductive paste for the coil structure and conductive paste for the outer electrodes are printed are laminated and then separated into individual green laminated inductors. In the method of manufacturing a laminated inductor described in Japanese Unexamined Patent Application Publication No. 2013-98356, the green laminated inductors are fired to obtain laminated inductors.

In the method of manufacturing a laminated inductor described in Japanese Unexamined Patent Application Publication No. 2013-98356, when the green laminated inductor is fired, the conductive paste for the outer electrodes and insulating paste for the insulator sheets, which are composed of different materials, need to be fired simultaneously. Hence in the method of manufacturing a laminated inductor described in Japanese Unexamined Patent Application Publication No. 2013-98356, there is a possibility that stress can remain in the laminated inductor obtained by firing the green laminated inductor, at the interfaces between the outer electrodes formed from the conductive paste for the outer electrodes and the insulation layers formed from the insulator sheets. This is because characteristics such as the rate of expansion and the modulus of elasticity are different between the conductive paste for the outer electrodes and the insulating paste for the insulator sheets. If stress remains at the interfaces between the outer electrodes and the insulation layers in a laminated inductor, for example, when the laminated inductor is mounted and a load (shock) is exerted on the laminated inductor, there is a possibility that a crack can occur inside the laminated inductor, starting from an interface as mentioned above.

Accordingly, the present disclosure provides an inductor component in which a crack due to stress remaining at the interface between the outer electrodes and the element body is less likely to occur.

An inductor component of the present disclosure includes an element body including an insulator; a coil located inside the element body; and a first outer electrode electrically connected to the coil. The element body includes a first end surface and a second end surface opposed to each other in a length direction, a first main surface and a second main surface opposed to each other in a height direction perpendicular to the length direction, and a first side surface and a second side surface opposed to each other in a width direction perpendicular to the length direction and the height direction. The first end surface intersects the first main surface on a first ridge line. The second end surface intersects the first main surface on a second ridge line. The first outer electrode includes a first electrode layer embedded in the element body such that at least part of the first electrode layer is exposed from the element body. The first electrode layer includes a portion extending from the first ridge line toward the second ridge line and exposed on the first main surface at a position away from the second ridge line and is not exposed on the second main surface. When in a section parallel to the length direction and the height direction and including the first electrode layer, a first point corresponding to the first ridge line, a second point corresponding to the second ridge line, and a third point corresponding to a distal end, on a second-ridge-line side, of the portion of the first electrode layer located on the first main surface are defined, the third point is located closer to the second main surface than is an imaginary straight line connecting the first point and the second point.

With the present disclosure, it is possible to provide an inductor component in which a crack due to stress remaining at the interface between the outer electrode and the element body is less likely to occur.

### BRIEF DESCRIPTION OF THE DRAWINGS

FIG. 1 is a schematic perspective view of an example of an inductor component according to the present disclosure;

FIG. 2 is a schematic sectional view of the inductor component illustrated in FIG. 1, illustrating an example of a section taken along line segment a1-a2; and

FIG. 3 is a schematic sectional view of another example of an inductor component according to the present disclosure.

### DETAILED DESCRIPTION

An inductor component of the present disclosure will be described below. The present disclosure is not limited to the following configurations, which may be changed as appropriate within a range not departing from the spirit of the present disclosure. A combination of two or more individual preferred configurations described in the following is also included in the present disclosure.

The following drawings are schematic, and hence, the dimensions, the scale of the ratio of longitudinal dimensions and lateral dimensions, and the like sometimes differ from those of the actual product.

In the present specification, unless otherwise noted, terms indicating relationships between components (for example, “parallel”, “perpendicular”, and the like) and terms indicating the shapes of components denote not only literal configurations in a strict sense but also substantially equivalent ranges such as ranges including differences of several percent.

An inductor component of the present disclosure includes an element body including an insulator; a coil located inside the element body; and a first outer electrode electrically connected to the coil. The element body includes a first end surface and a second end surface opposed to each other in a length direction, a first main surface and a second main surface opposed to each other in a height direction perpendicular to the length direction, and a first side surface and a second side surface opposed to each other in a width direction perpendicular to the length direction and the height direction. The first end surface intersects the first main surface on a first ridge line. The second end surface intersects the first main surface on a second ridge line. The first outer electrode includes a first electrode layer embedded in the element body such that at least part of the first electrode layer is exposed from the element body. The first electrode layer includes a portion extending from the first ridge line toward the second ridge line and exposed on the first main surface at a position away from the second ridge line and is not exposed on the second main surface. When in a section parallel to the length direction and the height direction and including the first electrode layer, a first point corresponding to the first ridge line, a second point corresponding to the second ridge line, and a third point corresponding to a distal end, on a second-ridge-line side, of the portion of the first electrode layer located on the first main surface are defined, the third point is located closer to the second main surface than is an imaginary straight line connecting the first point and the second point.

FIG. 1 is a schematic perspective view of an example of an inductor component according to the present disclosure.

The inductor component 1A illustrated in FIG. 1 includes an element body 10, a coil 20, and a first outer electrode 30a.

In the present specification, the length direction, the height direction, and the width direction are defined as the directions indicated by L, T, and W, respectively, as in FIG. 1 and other figures. The length direction L, the height direction T, and the width direction W are perpendicular to one another.

In the example illustrated in FIG. 1, the width direction W is parallel to the coil axis direction of the coil 20.

The coil axis direction of the coil 20 is the direction in which the coil axis C of the coil 20 extends.

The element body 10 has a first end surface 11a and a second end surface 11b opposed to each other in the length direction L, a first main surface 12a and a second main surface 12b opposed to each other in the height direction T, and a first side surface 13a and a second side surface 13b opposed to each other in the width direction W.

In the example illustrated in FIG. 1, the first main surface 12a extends in the coil axis direction (the width direction W in FIG. 1).

In the example illustrated in FIG. 1, the first main surface 12a is a mounting surface. Specifically, the first main surface 12a is the mounting surface which faces a mounting target object (for example, a substrate) when the inductor component 1A is mounted. Hence, in the inductor component 1A, the mounting surface corresponding to the first main surface 12a extends in the coil axis direction.

At least one of the surfaces of the element body 10, specifically, at least one of the first end surface 11a, the second end surface 11b, the first main surface 12a, the second main surface 12b, the first side surface 13a, and the second side surface 13b may have a marking to enable easy recognition of each surface.

The first end surface 11a and the second end surface 11b need not be strictly orthogonal to the length direction L. The first main surface 12a and the second main surface 12b need not be strictly orthogonal to the height direction T. Further, the first side surface 13a and the second side surface 13b need not be strictly orthogonal to the width direction W.

The element body 10 has, for example, a rectangular parallelepiped shape.

In the present specification, a rectangular parallelepiped shape may be a shape that looks substantially like a rectangular parallelepiped shape and includes, for example, a substantially rectangular parallelepiped shape with rounded corners or rounded ridge lines as described later.

It is preferable that at least either the corners or the ridge lines of the element body 10 be rounded.

A corner of the element body 10 is a portion at which three surfaces of the element body 10 intersect.

A ridge line of the element body 10 is a portion at which two surfaces of the element body 10 intersect.

In the example illustrated in FIG. 1, the first end surface 11a intersects the first main surface 12a on a first ridge line 14a. In the example illustrated in FIG. 1, the second end surface 11b intersects the first main surface 12a on a second ridge line 14b. In the example illustrated in FIG. 1, the first end surface 11a intersects the second main surface 12b on a third ridge line 14c. In the example illustrated in FIG. 1, the second end surface 11b intersects the second main surface 12b on a fourth ridge line 14d.

The element body 10 includes an insulator.

In the example illustrated in FIG. 1, the insulator includes a plurality of insulation layers laminated in the coil axis direction (the width direction W in FIG. 1).

In the example illustrated in FIG. 1, the plurality of insulation layers include an insulation layer 15a, an insulation layer 15b, an insulation layer 15c, and an insulation layer 15d.

Although not illustrated in FIG. 1, in reality, at least one insulation layer is present between the insulation layer 15b and the insulation layer 15c in the coil axis direction.

Although the boundaries between the plurality of insulation layers are illustrated in FIG. 1 for convenience of explanation, in reality, the plurality of insulation layers are united and do not have clear boundaries between them in many cases.

Examples of the insulating material composing the insulator, in this case, the insulating material composing the insulation layers, include glass materials containing borosilicate glass as a main component; ceramic materials; organic materials such as epoxy resins, fluororesins, and polymer resins; and composite materials such as glass epoxy resins. As for the insulating material, a material having low permittivity and low dielectric loss is particularly preferable.

The insulating materials composing the respective insulation layers may be the same or different, or some of them may be different.

The dimensions of the respective insulation layers in the coil axis direction may be the same or different, or some of them may be different.

The coil 20 is located inside the element body 10.

In the example illustrated in FIG. 1, the coil 20 is wound spirally in the coil axis direction.

In the example illustrated in FIG. 1, the coil 20 includes a plurality of coil wiring lines laminated in the coil axis direction and electrically connected.

In the example illustrated in FIG. 1, the plurality of coil wiring lines include first coil wiring 21a and second coil wiring 21b.

The first coil wiring 21a is located at the outermost position on the first-side-surface 13a side in the coil axis direction among the plurality of coil wiring lines.

The first coil wiring 21a may have a single layer structure or a multi-layer structure.

The second coil wiring 21b is located at the outermost position on the second-side-surface 13b side in the coil axis direction among the plurality of coil wiring lines.

The second coil wiring 21b may have a single layer structure or a multi-layer structure.

Although not illustrated in FIG. 1, in reality, at least one coil wiring line is present between the first coil wiring 21a and the second coil wiring 21b in the coil axis direction.

Examples of the conductive material composing the coil wiring include Ag, Au, Cu, Pd, Ni, Al, and alloys containing at least one of these metals.

The conductive materials composing the respective coil wiring lines may be the same or different, or some of them may be different.

The dimensions of the respective coil wiring lines in the coil axis direction may be the same or different, or some of them may be different.

The dimensions of the respective coil wiring lines in the direction perpendicular to the direction in which the coil wiring extends as viewed in the coil axis direction, in other words, the widths as viewed in the coil axis direction, are the same or different, or some of them may be different.

Adjacent coil wiring lines in the coil axis direction, of the plurality of coil wiring lines, may be electrically connected with a connecting conductor interposed between the adjacent coil wiring lines, the connecting conductor extending in the coil axis direction through the insulation layer between the adjacent coil wiring lines.

Each connecting conductor may have a single layer structure or a multi-layer structure.

Examples of the conductive material composing the connecting conductor include Ag, Au, Cu, Pd, Ni, Al, and alloys containing at least one of these metals.

When viewed in the coil axis direction, the coil 20 may have, for example, a shape including only straight line portions, a shape including only curved line portions, or a shape including straight line portions and curved line portions. When viewed in the coil axis direction, the coil 20 may have, for example, a polygonal shape including only straight line portions, a circular shape or an elliptical shape including only curved line portions, or an oval shape (stadium shape) including straight line portions and curved line portions.

As described above, in the example illustrated in FIG. 1, the coil 20 is composed of three or more coil wiring lines including the first coil wiring 21a, the second coil wiring 21b, and at least one coil wiring line. However, a configuration in which the coil 20 is composed of only two coil wiring lines is made possible by adjusting the position of the connecting conductor.

The first outer electrode 30a is electrically connected to the coil 20.

In the example illustrated in FIG. 1, the first outer electrode 30a is electrically connected to one end portion of the coil 20. Specifically, the first outer electrode 30a is electrically connected to the first coil wiring 21a, included in the coil 20, with first extended wiring 22a interposed therebetween. In other words, the first extended wiring 22a connects the first coil wiring 21a and the first outer electrode 30a.

The first extended wiring 22a may have a single layer structure or a multi-layer structure.

Examples of the conductive material composing the extended wiring include Ag, Au, Cu, Pd, Ni, Al, and alloys containing at least one of these metals.

In the present specification, in a path through which the coil wiring is electrically connected to an outer electrode, extended wiring refers to wiring inclined relative to a straight line portion of the coil wiring and extending toward the outer electrode as viewed in the coil axis direction (for example, the example illustrated in FIG. 1). In this case, when viewed in the coil axis direction, the coil wiring and the extended wiring are not on the same straight line with their connection portion as the boundary. In the case in which wiring corresponding to extended wiring as defined above is not present when viewed in the coil axis direction, wiring not overlapping the circling portion of the coil (protruding from the circling portion of the coil) as viewed in the coil axis direction is defined as extended wiring (for example, an example different from the one in FIG. 1).

The first outer electrode 30a includes a first electrode layer 31a embedded in the element body 10 such that at least part of the first electrode layer 31a is exposed from the element body 10.

The first electrode layer 31a includes a portion extending from the first ridge line 14a toward the second ridge line 14b and exposed on the first main surface 12a at a position away from the second ridge line 14b. In other words, the first electrode layer 31a is exposed in a portion of the first main surface 12a.

In the example illustrated in FIG. 1, the first electrode layer 31a is exposed in a portion of the first main surface 12a on the first-ridge-line 14a side. Specifically, the first electrode layer 31a is exposed in a region of the first main surface 12a closer to the first ridge line 14a than to the center of the first main surface 12a in the length direction L.

As illustrated in FIG. 1, it is preferable that the first electrode layer 31a further include a portion extending from the first main surface 12a via the first ridge line 14a to the first end surface 11a and exposed on the first end surface 11a.

In the example illustrated in FIG. 1, the first electrode layer 31a is exposed extending over a portion of the first main surface 12a on the first-ridge-line 14a side and a portion of the first end surface 11a on the first-ridge-line 14a side.

Note that a configuration in which the first electrode layer 31a is exposed only in a portion of the first main surface 12a is also possible.

Meanwhile, the first electrode layer 31a is not exposed on the second main surface 12b.

The dimension of the first electrode layer 31a in the coil axis direction may be less than or the same as the dimension of the first ridge line 14a in the coil axis direction (the dimension of the element body 10 in the coil axis direction). In other words, the first electrode layer 31a may be in contact with part or all of the first ridge line 14a.

As illustrated in FIG. 1, it is preferable that the first outer electrode 30a further include a second electrode layer 31b located outside the element body 10 and covering the first electrode layer 31a. In other words, it is preferable that the first outer electrode 30a include the first electrode layer 31a and the second electrode layer 31b in this order from the coil 20 side.

It is preferable that the second electrode layer 31b be in contact with the first electrode layer 31a.

It is preferable that the second electrode layer 31b extend from the first ridge line 14a toward the second ridge line 14b at a position away from the second ridge line 14b and outside the element body 10, specifically, on the first main surface 12a. In other words, it is preferable that the second electrode layer 31b be located on a portion of the first main surface 12a.

In the example illustrated in FIG. 1, the second electrode layer 31b is located on a portion of the first main surface 12a on the first-ridge-line 14a side. Specifically, the second electrode layer 31b is located on a region of the first main surface 12a closer to the first ridge line 14a than to the center of the first main surface 12a in the length direction L.

As illustrated in FIG. 1, it is preferable that the second electrode layer 31b further include a portion extending from the first main surface 12a via the first ridge line 14a to the first end surface 11a.

In the example illustrated in FIG. 1, the second electrode layer 31b extends from a portion of the first main surface 12a on the first-ridge-line 14a side to a portion of the first end surface 11a on the first-ridge-line 14a side.

Note that a configuration in which the second electrode layer 31b is located only on a portion of the first main surface 12a is also possible.

Meanwhile, it is preferable that the second electrode layer 31b not be located on the second main surface 12b.

The dimension of the second electrode layer 31b in the coil axis direction may be less than or the same as the dimension of the first ridge line 14a in the coil axis direction (the dimension of the element body 10 in the coil axis direction). In other words, the second electrode layer 31b may be in contact with part or all of the first ridge line 14a.

Examples of the conductive material composing the electrode layers include Ag, Au, Cu, Pd, Ni, Al, and alloys containing at least one of these metals.

In the case in which the first outer electrode 30a includes the first electrode layer 31a and the second electrode layer 31b, it is preferable that the first electrode layer 31a be a base electrode layer containing one of the aforementioned conductive materials and that the second electrode layer 31b be a plating electrode layer containing one of the aforementioned conductive materials. In this case, it is preferable that the first outer electrode 30a include a Ag base electrode layer as the first electrode layer 31a and a Ni plating electrode layer as the second electrode layer 31b in this order from the coil 20 side. In addition, it is more preferable that the first outer electrode 30a include a Ag base electrode layer as the first electrode layer 31a, a Ni plating electrode layer as the second electrode layer 31b, and a Sn plating electrode layer as another electrode layer covering the second electrode layer 31b, in this order from the coil 20 side.

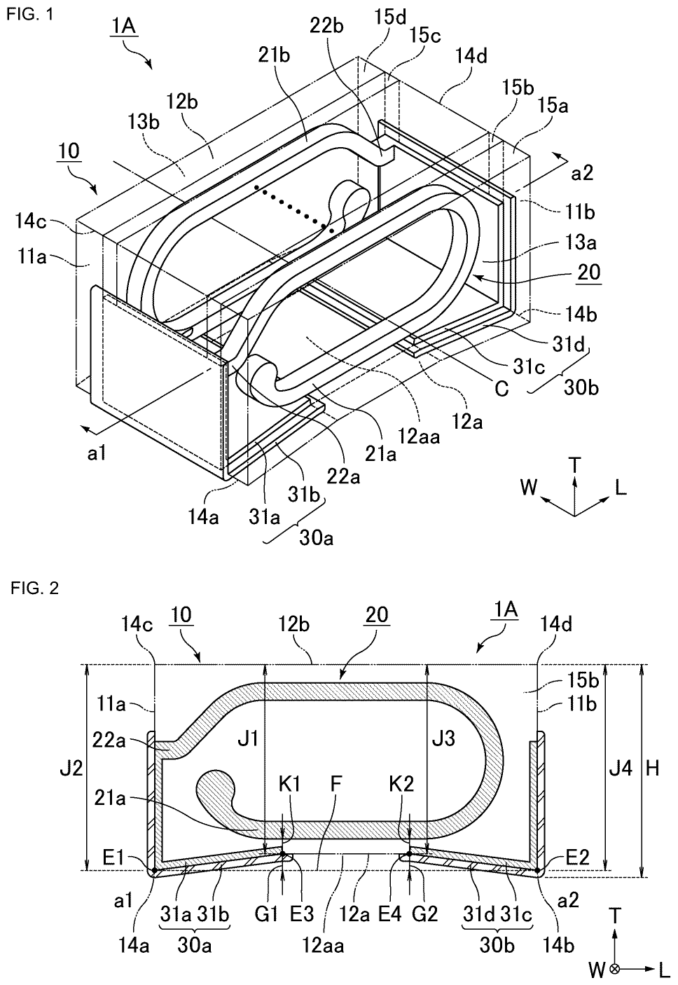

FIG. 2 is a schematic sectional view of the inductor component in FIG. 1, illustrating an example of a section taken along line segment a1-a2. Specifically, FIG. 2 illustrates a section of the inductor component 1A illustrated in FIG. 1, parallel to the length direction L and the height direction T and including the first coil wiring 21a and the first electrode layer 31a.

As illustrated in FIG. 2, in a section parallel to the length direction L and the height direction T and including the first electrode layer 31a, a first point E1 corresponding to the first ridge line 14a, a second point E2 corresponding to the second ridge line 14b, and a third point E3 corresponding to the distal end, on the second-ridge-line 14b side, of the portion of the first electrode layer 31a located on the first main surface 12a are defined. The third point E3 may also be said to correspond to the intersection point of the first main surface 12a and the interface between the first electrode layer 31a and the element body 10 (insulator).

When the first point E1, the second point E2, and the third point E3 are defined as illustrated in FIG. 2, the third point E3 is located closer to the second main surface 12b than is an imaginary straight line F connecting the first point E1 and the second point E2.

In an inductor component of the related art (for example, the laminated inductor described in Japanese Unexamined Patent Application Publication No. 2013-98356), when the outer electrodes and the element body (insulator) are formed by a method in which these components are fired simultaneously (which is also referred to as a cofiring method), there is a possibility that stress can remain at the interface between the outer electrodes and the element body (insulator) because characteristics such as the rate of expansion and the modulus of elasticity are different between the materials composing the outer electrodes and the element body (insulator). For example, when an inductor component is mounted, or when inductor components are transported in equipment such as a characteristic sorting machine, a load (shock) can be exerted on the inductor component. In the case of inductor components of the related art, when stress remains at the interface of the outer electrodes and the element body (insulator), there is a possibility that a crack can occur inside the inductor component, starting from an interface as mentioned above. In an inductor component of the related art, in the interface of the outer electrodes and the element body (insulator) where stress can remain as described above, a crack is likely to occur starting from the distal ends of the outer electrodes located on the main surface (the mounting surface) of the element body.

However, in the case of the inductor component 1A, in the interface between the outer electrode and the element body 10 (insulator), in this case, in the interface between the first electrode layer 31a and the element body 10 (insulator), the third point E3 corresponding to the distal end, on the second-ridge-line 14b side, of the portion of the first electrode layer 31a located on the first main surface 12a is located closer to the second main surface 12b than is the imaginary straight line F connecting the first point E1 and the second point E2. In other words, in the inductor component 1A, the height position of the third point E3 is closer to the second main surface 12b than the height positions of the first point E1 and the second point E2 are, on the first main surface 12a. Hence, for example, when an inductor component 1A is mounted, or when inductor components 1A are transported in equipment such as a characteristic sorting machine, the load exerted on the inductor component 1A when the inductor component 1A is placed with the first main surface 12a as the mounting surface is less likely to be concentrated at the third point E3. Thus, in the inductor component 1A, even if stress remains at the interface between the first electrode layer 31a and the element body 10 (insulator), a crack due to the stress caused, for example, when the inductor component 1A is mounted is less likely to occur starting from the third point E3.

Thus, with the inductor component 1A, it is possible to provide an inductor component in which a crack due to stress remaining at the interface between the outer electrode and the element body 10 (insulator), in this case, the interface between the first electrode layer 31a and the element body 10 (insulator) is less likely to occur.

In the inductor component 1A, the third point E3 needs only to be located closer to the second main surface 12b than the imaginary straight line F be in any section parallel to the length direction L and the height direction T and including the first electrode layer 31a. As for the inductor component 1A, the relationship in which the third point E3 is located closer to the second main surface 12b than the imaginary straight line F is may hold, for example, in a section including the first coil wiring 21a and the first electrode layer 31a (see FIG. 2), may hold in a section including the second coil wiring 21b and the first electrode layer 31a, or may hold in both of the sections, out of the sections parallel to the length direction L and the height direction T. However, it is particularly preferable that the relationship hold in all the sections including the first electrode layer 31a.

In the inductor component 1A, it is preferable that the entire outline connecting the first point E1 and the third point E3 on the first main surface 12a be located closer to the second main surface 12b than the imaginary straight line F be in any section parallel to the length direction L and the height direction T and including the first electrode layer 31a, as illustrated in FIG. 2. In other words, in the inductor component 1A, it is preferable that no portion of the outline connecting the first point E1 and the third point E3 on the first main surface 12a protrude beyond the imaginary straight line F to the side opposite to the second main surface 12b as illustrated in FIG. 2 in any section parallel to the length direction L and the height direction T and including the first electrode layer 31a.

Note that as for the inductor component 1A, as long as the third point E3 is located closer to the second main surface 12b than the imaginary straight line F is in any section parallel to the length direction L and the height direction T and including the first electrode layer 31a, a configuration in which part of the outline connecting the first point E1 and the third point E3 on the first main surface 12a is located on the side of the imaginary straight line F opposite to the second main surface 12b is also possible. In other words, as for the inductor component 1A, a configuration in which part of the outline connecting the first point E1 and the third point E3 on the first main surface 12a protrudes beyond the imaginary straight line F to the side opposite to the second main surface 12b in a section parallel to the length direction L and the height direction T and including the first electrode layer 31a is also possible.

It is preferable that the distance G1 between the third point E3 and the imaginary straight line F in the height direction T be 2 μm or more and 12 μm or less (i.e., from 2 μm to 12 μm).

In the example illustrated in FIG. 2, the distance G1 between the third point E3 and the imaginary straight line F in the height direction T corresponds to the dimension of the perpendicular drawn from the third point E3 to the imaginary straight line F.

In the case in which the distance G1 between the third point E3 and the imaginary straight line F in the height direction Tis 2 μm or more and 12 μm or less (i.e., from 2 μm to 12 μm), occurrence of the aforementioned crack is sufficiently prevented, and also decrease in the L value (inductance) and the Q factor (quality factor) is sufficiently prevented.

If the distance G1 between the third point E3 and the imaginary straight line F in the height direction T is less than 2 μm, the inductor component 1A is, in some cases, less likely to provide the effect that the load exerted on the inductor component 1A, for example, when the inductor component 1A is mounted is less likely to be concentrated at the third point E3. Hence, if the distance G1 between the third point E3 and the imaginary straight line F in the height direction T is less than 2 μm, the inductor component 1A is, in some cases, less likely to provide the effect that the aforementioned crack is less likely to occur starting from the third point E3.

If the distance G1 between the third point E3 and the imaginary straight line F in the height direction T is more than 12 μm, the region for providing the coil 20 in the element body 10 (for example, the distance J1 between the third point E3 and the second main surface 12b in the height direction T) is too small, which makes the inner diameter of the coil 20 too small, so that the L value and the Q factor are, in some cases, more likely to decrease.

It is preferable that the distance G1 between the third point E3 and the imaginary straight line F in the height direction T be 1% or more and 7% or less (i.e., from 1% to 7%) of the maximum dimension H of the inductor component 1A in the height direction T.

In the case in which the distance G1 between the third point E3 and the imaginary straight line F in the height direction Tis 1% or more and 7% or less (i.e., from 1% to 7%) of the maximum dimension H of the inductor component 1A in the height direction T, occurrence of the aforementioned crack is sufficiently prevented, and also decrease in the L value and the Q factor is sufficiently prevented.

If the distance G1 between the third point E3 and the imaginary straight line F in the height direction T is less than 1% of the maximum dimension H of the inductor component 1A in the height direction T, the inductor component 1A is, in some cases, less likely to provide the effect that the load exerted on the inductor component 1A, for example, when the inductor component 1A is mounted is less likely to be concentrated at the third point E3. Hence, if the distance G1 between the third point E3 and the imaginary straight line F in the height direction T is less than 1% of the maximum dimension H of the inductor component 1A in the height direction T, the inductor component 1A is, in some cases, less likely to provide the effect that the aforementioned crack is less likely to occur starting from the third point E3.

If the distance G1 between the third point E3 and the imaginary straight line F in the height direction T is more than 7% of the maximum dimension H of the inductor component 1A in the height direction T, the region for providing the coil 20 in the element body 10 (for example, the distance J1 between the third point E3 and the second main surface 12b in the height direction T) is too small, which makes the inner diameter of the coil 20 too small, so that the L value and the Q factor are, in some cases, more likely to decrease.

It is preferable that the distance J1 between the third point E3 and the second main surface 12b in the height direction T be less than the distance J2 between the first point E1 and the second main surface 12b in the height direction T.

In the example illustrated in FIG. 2, the difference between the distance J1 between the third point E3 and the second main surface 12b in the height direction T and the distance J2 between the first point E1 and the second main surface 12b in the height direction T corresponds to the distance G1 between the third point E3 and the imaginary straight line F in the height direction T.

It is preferable that the minimum distance K1 between the third point E3 and the surface of the coil 20 be 25 μm or less.

In inductor components of the related art, in order to prevent, in case of occurrence of the aforementioned crack, the crack from reaching the coil and exerting a baneful influence on the coil characteristics, the first electrode layer and the coil are arranged to be sufficiently away from each other in many cases. Hence, inductor components of the related art have a limit in terms of reducing the distance between the first electrode layer and the coil to increase the L value.

In contrast, in the inductor component 1A, since occurrence of the aforementioned crack is sufficiently prevented, the first electrode layer 31a and the coil 20 need not be arranged to be far away from each other. Hence, in the inductor component 1A, the first electrode layer 31a and the coil 20 can be arranged to be closer to each other such that the minimum distance K1 between the third point E3 and the surface of the coil 20 can be 25 μm or less, so that the L value can be increased.

As illustrated in FIG. 1, it is preferable that the inductor component 1A further include a second outer electrode 30b.

The second outer electrode 30b is located at a position away from the first outer electrode 30a.

In the example illustrated in FIG. 1, the second outer electrode 30b is located at a position away from the first outer electrode 30a in a direction perpendicular to the coil axis direction, or in the length direction L in FIG. 1.

The second outer electrode 30b is electrically connected to the coil 20.

In the example illustrated in FIG. 1, the second outer electrode 30b is electrically connected to the other end portion of the coil 20. Specifically, the second outer electrode 30b is electrically connected to the second coil wiring 21b, included in the coil 20, with second extended wiring 22b interposed therebetween. In other words, the second extended wiring 22b connects the second coil wiring 21b and the second outer electrode 30b.

The second extended wiring 22b may have a single layer structure or a multi-layer structure.

The conductive material composing the second extended wiring 22b may be the same as or different from the conductive material composing the first extended wiring 22a.

It is preferable that the second outer electrode 30b include a third electrode layer 31c embedded in the element body 10 such that at least part of the third electrode layer 31c is exposed from the element body 10.

It is preferable that the third electrode layer 31c include a portion extending from the second ridge line 14b toward the first ridge line 14a and exposed on the first main surface 12a at a position away from the first electrode layer 31a. In other words, it is preferable that the third electrode layer 31c be exposed in a portion of the first main surface 12a at a position away from the first electrode layer 31a.

In the example illustrated in FIG. 1, the third electrode layer 31c is exposed in a portion of the first main surface 12a on the second-ridge-line 14b side. Specifically, the third electrode layer 31c is exposed in a region of the first main surface 12a closer to the second ridge line 14b than to the center of the first main surface 12a in the length direction L.

As illustrated in FIG. 1, it is preferable that the third electrode layer 31c further include a portion extending from the first main surface 12a via the second ridge line 14b to the second end surface 11b and exposed on the second end surface 11b.

In the example illustrated in FIG. 1, the third electrode layer 31c is exposed extending over a portion of the first main surface 12a on the second-ridge-line 14b side and a portion of the second end surface 11b on the second-ridge-line 14b side.

Note that a configuration in which the third electrode layer 31c is exposed only in a portion of the first main surface 12a at a position away from the first electrode layer 31a is possible.

Meanwhile, the third electrode layer 31c is not exposed on the second main surface 12b.

The dimension of the third electrode layer 31c in the coil axis direction may be less than or the same as the dimension of the second ridge line 14b in the coil axis direction (the dimension of the element body 10 in the coil axis direction). In other words, the third electrode layer 31c may be in contact with part or all of the second ridge line 14b.

As illustrated in FIG. 1, it is preferable that the second outer electrode 30b further include a fourth electrode layer 31d located outside the element body 10 and covering the third electrode layer 31c. In other words, it is preferable that the second outer electrode 30b include the third electrode layer 31c and the fourth electrode layer 31d in this order from the coil 20 side.

It is preferable that the fourth electrode layer 31d be in contact with the third electrode layer 31c.

It is preferable that the fourth electrode layer 31d extend from the second ridge line 14b toward the first ridge line 14a at a position away from the first ridge line 14a and outside the element body 10, specifically, on the first main surface 12a. In other words, it is preferable that the fourth electrode layer 31d be located on a portion of the first main surface 12a.

In the case in which the first outer electrode 30a includes the second electrode layer 31b, it is preferable that the fourth electrode layer 31d extend from the second ridge line 14b toward the first ridge line 14a at a position away from the second electrode layer 31b and outside the element body 10, specifically, on the first main surface 12a. In other words, it is preferable that the fourth electrode layer 31d be located on a portion of the first main surface 12a at a position away from the second electrode layer 31b.

In the example illustrated in FIG. 1, the fourth electrode layer 31d is located on a portion of the first main surface 12a on the second-ridge-line 14b side. Specifically, the fourth electrode layer 31d is located on a region of the first main surface 12a closer to the second ridge line 14b than to the center of the first main surface 12a in the length direction L.

It is preferable that the fourth electrode layer 31d further include a portion extending from the first main surface 12a via the second ridge line 14b to the second end surface 11b as illustrated in FIG. 1.

In the example illustrated in FIG. 1, the fourth electrode layer 31d extends from a portion of the first main surface 12a on the second-ridge-line 14b side to a portion of the second end surface 11b on the second-ridge-line 14b side.

Note that a configuration in which the fourth electrode layer 31d is located only on a portion of the first main surface 12a is also possible. In the case in which the first outer electrode 30a includes the second electrode layer 31b, a configuration in which the fourth electrode layer 31d is located only on a portion of the first main surface 12a at a position away from the second electrode layer 31b is also possible.

Meanwhile, it is preferable that the fourth electrode layer 31d not be located on the second main surface 12b.

The dimension of the fourth electrode layer 31d in the coil axis direction may be less than or the same as the dimension of the second ridge line 14b in the coil axis direction (the dimension of the element body 10 in the coil axis direction). In other words, the fourth electrode layer 31d may be in contact with part or all of the second ridge line 14b.

In the case in which the second outer electrode 30b includes the third electrode layer 31c and the fourth electrode layer 31d, it is preferable that the third electrode layer 31c be a base electrode layer containing one of the aforementioned conductive materials and that the fourth electrode layer 31d be a plating electrode layer containing one of the aforementioned conductive materials. In this case, it is preferable that the second outer electrode 30b include a Ag base electrode layer as the third electrode layer 31c and a Ni plating electrode layer as the fourth electrode layer 31d in this order from the coil 20 side. In addition, it is more preferable that the second outer electrode 30b include a Ag base electrode layer as the third electrode layer 31c, a Ni plating electrode layer as the fourth electrode layer 31d, and a Sn plating electrode layer as another electrode layer covering the fourth electrode layer 31d, in this order from the coil 20 side.

In the section illustrated in FIG. 2, in addition to the first point E1, the second point E2, and the third point E3, a fourth point E4 corresponding to the distal end, on the first-ridge-line 14a side, of the portion of the third electrode layer 31c located on the first main surface 12a is defined. The fourth point E4 may also be said to correspond to the intersection point of the first main surface 12a and the interface between the third electrode layer 31c and the element body 10 (insulator).

When the first point E1, the second point E2, the third point E3, and the fourth point E4 are defined as illustrated in FIG. 2, it is preferable that the fourth point E4 be located closer to the second main surface 12b than the imaginary straight line F be.

In the inductor component 1A, in the interface between an outer electrode and the element body 10 (insulator), in this case, in the interface between the third electrode layer 31c and the element body 10 (insulator), the fourth point E4 corresponding to the distal end, on the first-ridge-line 14a side, of the portion of the third electrode layer 31c located on the first main surface 12a is located closer to the second main surface 12b than is the imaginary straight line F. Hence, when the inductor component 1A is placed with the first main surface 12a as the mounting surface, for example, to mount the inductor component 1A, the load exerted on the inductor component 1A is less likely to be concentrated at the fourth point E4 as in the case of the third point E3. Thus, in the inductor component 1A, even if stress remains at the interface between the third electrode layer 31c and the element body 10 (insulator), a crack due to the stress caused, for example, when the inductor component 1A is mounted is less likely to occur starting from the fourth point E4.

In the inductor component 1A, it is preferable that the fourth point E4 be located closer to the second main surface 12b than the imaginary straight line F be in any section parallel to the length direction L and the height direction T and including the first electrode layer 31a and the third electrode layer 31c. As for the inductor component 1A, the relationship in which the fourth point E4 is located closer to the second main surface 12b than the imaginary straight line F is may hold, for example, in a section including the first coil wiring 21a, the first electrode layer 31a, and the third electrode layer 31c (see FIG. 2), may hold in a section including the second coil wiring 21b, the first electrode layer 31a, and the third electrode layer 31c, or may hold in both of the sections, out of the sections parallel to the length direction L and the height direction T. However, it is particularly preferable that the relationship hold in all the sections including the first electrode layer 31a and the third electrode layer 31c.

In the inductor component 1A, it is preferable that the entire outline connecting the second point E2 and the fourth point E4 on the first main surface 12a be located closer to the second main surface 12b than the imaginary straight line F be as illustrated in FIG. 2 in any section parallel to the length direction L and the height direction T and including the first electrode layer 31a and the third electrode layer 31c. In other words, in the inductor component 1A, it is preferable that no portion of the outline connecting the second point E2 and the fourth point E4 on the first main surface 12a protrude beyond the imaginary straight line F to the side opposite to the second main surface 12b as illustrated in FIG. 2 in any section parallel to the length direction L and the height direction T and including the first electrode layer 31a and the third electrode layer 31c.

Note that as for the inductor component 1A, in the case in which the fourth point E4 is located closer to the second main surface 12b than the imaginary straight line F is in any section parallel to the length direction L and the height direction T and including the first electrode layer 31a and the third electrode layer 31c, a configuration in which part of the outline connecting the second point E2 and the fourth point E4 on the first main surface 12a is located on the side of the imaginary straight line F opposite to the second main surface 12b is also possible. In other words, as for the inductor component 1A, a configuration in which part of the outline connecting the second point E2 and the fourth point E4 on the first main surface 12a protrudes beyond the imaginary straight line F to the side opposite to the second main surface 12b in a section parallel to the length direction L and the height direction T and including the first electrode layer 31a and the third electrode layer 31c is also possible.

In the example illustrated in FIG. 2, the entire outline connecting the first point E1 and the third point E3 on the first main surface 12a and the entire outline connecting the second point E2 and the fourth point E4 on the first main surface 12a are located closer to the second main surface 12b than the imaginary straight line F is, and the first main surface 12a has a recessed shape recessed toward the second main surface 12b.

It is preferable that the distance G2 between the fourth point E4 and the imaginary straight line F in the height direction T be 2 μm or more and 12 μm or less (i.e., from 2 μm to 12 μm).

In the example illustrated in FIG. 2, the distance G2 between the fourth point E4 and the imaginary straight line F in the height direction T corresponds to the dimension of the perpendicular drawn from the fourth point E4 to the imaginary straight line F.

In the case in which the distance G2 between the fourth point E4 and the imaginary straight line F in the height direction T is 2 μm or more and 12 μm or less (i.e., from 2 μm to 12 μm), occurrence of the aforementioned crack is sufficiently prevented, and also decrease in the L value and the Q factor is sufficiently prevented.

If the distance G2 between the fourth point E4 and the imaginary straight line F in the height direction T is less than 2 μm, the inductor component 1A is, in some cases, less likely to provide the effect that the load exerted on the inductor component 1A, for example, when the inductor component 1A is mounted is less likely to be concentrated at the fourth point E4. Hence, if the distance G2 between the fourth point E4 and the imaginary straight line F in the height direction T is less than 2 μm, the inductor component 1A is, in some cases, less likely to provide the effect that the aforementioned crack is less likely to occur starting from the fourth point E4.

If the distance G2 between the fourth point E4 and the imaginary straight line Fin the height direction T is more than 12 μm, the region for providing the coil 20 in the element body 10 (for example, the distance J3 between the fourth point E4 and the second main surface 12b in the height direction T) is too small, which makes the inner diameter of the coil 20 too small, so that the L value and the Q factor are, in some cases, more likely to decrease.

It is preferable that the distance G2 between the fourth point E4 and the imaginary straight line F in the height direction T be 1% or more and 7% or less (i.e., from 1% to 7%) of the maximum dimension H of the inductor component 1A in the height direction T.

In the case in which the distance G2 between the fourth point E4 and the imaginary straight line F in the height direction Tis 1% or more and 7% or less (i.e., from 1% to 7%) of the maximum dimension H of the inductor component 1A in the height direction T, occurrence of the aforementioned crack is sufficiently prevented, and also decrease in the L value and the Q factor is sufficiently prevented.

If the distance G2 between the fourth point E4 and the imaginary straight line F in the height direction T is less than 1% of the maximum dimension H of the inductor component 1A in the height direction T, the inductor component 1A is, in some cases, less likely to provide the effect that the load exerted on the inductor component 1A, for example, when the inductor component 1A is mounted is less likely to be concentrated at the fourth point E4. Hence, if the distance G2 between the fourth point E4 and the imaginary straight line F in the height direction T is less than 1% of the maximum dimension H of the inductor component 1A in the height direction T, the inductor component 1A is, in some cases, less likely to provide the effect that the aforementioned crack is less likely to occur starting from the fourth point E4.

If the distance G2 between the fourth point E4 and the imaginary straight line Fin the height direction T is more than 7% of the maximum dimension H of the inductor component 1A in the height direction T, the region for providing the coil 20 in the element body 10 (for example, the distance J3 between the fourth point E4 and the second main surface 12b in the height direction T) is too small, which makes the inner diameter of the coil 20 too small, so that the L value and the Q factor are, in some cases, more likely to decrease.

It is preferable that the distance J3 between the fourth point E4 and the second main surface 12b in the height direction T be less than the distance J4 between the second point E2 and the second main surface 12b in the height direction T.

In the example illustrated in FIG. 2, the difference between the distance J3 between the fourth point E4 and the second main surface 12b in the height direction T and the distance J4 between the second point E2 and the second main surface 12b in the height direction T corresponds to the distance G2 between the fourth point E4 and the imaginary straight line F in the height direction T.

It is preferable that the distance J3 between the fourth point E4 and the second main surface 12b in the height direction T be the same as the distance J1 between the third point E3 and the second main surface 12b in the height direction T.

However, the distance J3 between the fourth point E4 and the second main surface 12b in the height direction T may differ from the distance J1 between the third point E3 and the second main surface 12b in the height direction T. In this case, the distance J3 between the fourth point E4 and the second main surface 12b in the height direction T may be more than or less than the distance J1 between the third point E3 and the second main surface 12b in the height direction T.

It is preferable that the distance J3 between the fourth point E4 and the second main surface 12b in the height direction T be less than the distance J2 between the first point E1 and the second main surface 12b in the height direction T.

It is preferable that the distance J4 between the second point E2 and the second main surface 12b in the height direction T be more the distance J1 between the third point E3 and the second main surface 12b in the height direction T. In other words, it is preferable that the distance J1 between the third point E3 and the second main surface 12b in the height direction T be less than the distance J4 between the second point E2 and the second main surface 12b in the height direction T.

It is preferable that the distance J4 between the second point E2 and the second main surface 12b in the height direction T be the same as the distance J2 between the first point E1 and the second main surface 12b in the height direction T.

However, the distance J4 between the second point E2 and the second main surface 12b in the height direction T may differ from the distance J2 between the first point E1 and the second main surface 12b in the height direction T. In this case, the distance J4 between the second point E2 and the second main surface 12b in the height direction T may be more than or less than the distance J2 between the first point E1 and the second main surface 12b in the height direction T.

It is preferable that the minimum distance K2 between the fourth point E4 and the surface of the coil 20 be 25 μm or less.

Since occurrence of the aforementioned crack is prevented in the inductor component 1A, the third electrode layer 31c and the coil 20 need not be arranged to be far away from each other. Hence, in the inductor component 1A, the third electrode layer 31c and the coil 20 can be arranged to be closer to each other such that the minimum distance K2 between the fourth point E4 and the surface of the coil 20 can be 25 μm or less, so that the L value can be increased.

As illustrated in FIGS. 1 and 2, it is preferable that the first main surface 12a include a flat portion 12aa located between the first outer electrode 30a and the second outer electrode 30b. In other words, the first outer electrode 30a and the second outer electrode 30b are not present in the flat portion 12aa of the first main surface 12a. Specifically, the first electrode layer 31a and the third electrode layer 31c are not exposed in the flat portion 12aa of the first main surface 12a, and the second electrode layer 31b and the fourth electrode layer 31d are not present on the flat portion 12aa of the first main surface 12a.

As illustrated in FIGS. 1 and 2, it is preferable that the second main surface 12b be parallel to the flat portion 12aa of the first main surface 12a. In other words, it is preferable that the second main surface 12b be flat as with the flat portion 12aa of the first main surface 12a.

The state in which the second main surface 12b is parallel to the flat portion 12aa of the first main surface 12a denotes the state in which when it is assumed that the outline of the second main surface 12b is moved in the height direction T in a sections parallel to the length direction L and the height direction T as illustrated in FIG. 2 so as to overlap the outline (which is preferably a straight line) of the flat portion 12aa of the first main surface 12a, the entire outline of the second main surface 12b is within the range of +1 μm in the height direction T with respect to the outline of the flat portion 12aa of the first main surface 12a.

In the inductor component 1A, in the case in which the second main surface 12b is parallel to the flat portion 12aa of the first main surface 12a, for example, when a mounter picks up (for example, suctions) the inductor component 1A from the side of the second main surface 12b to mount the inductor component 1A, the load exerted on the inductor component 1A is less likely to be concentrated locally on the second main surface 12b, for example, on the third ridge line 14c and the fourth ridge line 14d. Hence, the load exerted on the inductor component 1A from the mounter when the inductor component 1A is mounted is less likely to cause the inductor component 1A to chip or break on the second main surface 12b.

Note that in the inductor component, the second main surface 12b being parallel to the flat portion 12aa of the first main surface 12a is not essential.

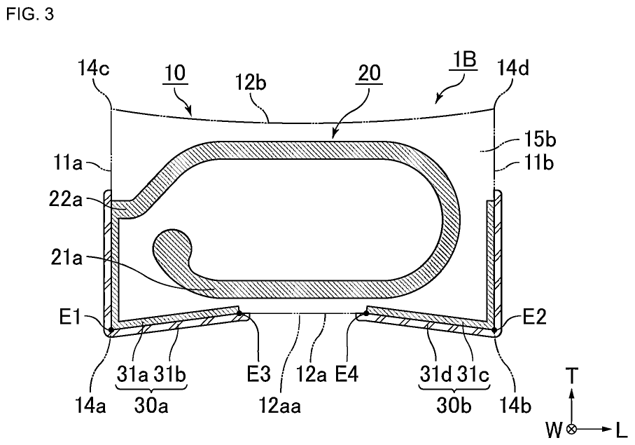

FIG. 3 is a schematic sectional view of another example of an inductor component according to the present disclosure.

In the inductor component 1B illustrated in FIG. 3, the second main surface 12b is not parallel to the flat portion 12aa of the first main surface 12a.

In the example illustrated in FIG. 3, the second main surface 12b has a recessed shape recessed toward the first main surface 12a.

When a mounter picks up the inductor component 1B from the side of the second main surface 12b to mount the inductor component 1B, the load exerted on the inductor component 1B is, in some cases, more likely to be concentrated locally on the second main surface 12b, in this case, on the third ridge line 14c and the fourth ridge line 14d. Hence, when the inductor component 1B is mounted, compared with when the inductor component 1A is mounted, the load exerted on the inductor component 1B from the mounter is, in some cases, more likely to cause the inductor component 1B to chip and break on the second main surface 12b.

Hence, as compared with the inductor component 1B, the inductor component 1A is less likely to cause problems such as chipping or breaking of the second main surface 12b due to the load exerted in mounting.

Although the description above is based on a configuration example in which the coil axis direction is parallel to the width direction W, the coil axis direction may be parallel to the length direction L or may be parallel to the height direction T.

In the case in which the coil axis direction is parallel to the length direction L or the width direction W, it is preferable that the flat portion 12aa of the first main surface 12a be parallel to the coil axis direction.

In the case in which the coil axis direction is parallel to the height direction T, it is preferable that the flat portion 12aa of the first main surface 12a be perpendicular to the coil axis direction.

The inductor component 1A is manufactured, for example, by the following method.

### <Process of Producing Mother Multilayer Body>

First, for example, an application of an insulating paste containing a glass material containing borosilicate glass as a main component is repeatedly performed by screen printing or the like to form an insulating paste layer. The insulating paste layer formed in this process later serves as the insulation layer 15a.

Next, for example, an application of a photosensitive conductive paste containing Ag as a main component is performed by screen printing or the like to form a photosensitive conductive paste layer on the insulating paste layer. Next, the photosensitive conductive paste layer is irradiated with ultraviolet rays or the like through a photomask and then developed with an alkaline solution or the like to form a coil conductor layer, outer conductor layers, and an extended conductor layer connected to the coil conductor layer and the outer conductor layers on the insulating paste layer. The coil conductor layer, the extended conductor layer, and the outer conductor layers are formed in two or more places by the photolithography method as described above. The coil conductor layer formed in this process later serves as the first coil wiring 21a. The extended conductor layer formed in this process later serves as the first extended wiring 22a connecting the first coil wiring 21a and the first outer electrode 30a (specifically, the first electrode layer 31a). The outer conductor layers formed in this process later serve as part of the first electrode layer 31a included in the first outer electrode 30a and part of the third electrode layer 31c included in the second outer electrode 30b.

Note that to form the coil conductor layer, the extended conductor layer, and the outer conductor layers, for example, DI exposure (also referred to as direct imaging exposure) which does not use a photomask may be performed instead of the exposure using a photomask.

Next, for example, an application of a photosensitive insulating paste is performed by screen printing or the like to form a new insulating paste layer on the insulating paste layer already formed. The newly-formed insulating paste layer is irradiated with ultraviolet rays or the like through a photomask and then developed with an alkaline solution or the like to form via holes and openings in the insulating paste layer. The insulating paste layer having a plurality of via holes and a plurality of openings is thus formed by the photolithography method. The insulating paste layer formed in this process includes one that later serves as the insulation layer 15b. The via holes formed in this process overlap part of the coil conductor layer already formed. The openings formed in this process overlap the outer conductor layers already formed.

Note that to form the insulating paste layer having via holes and openings, for example, DI exposure which does not use a photomask may be performed instead of the exposure using a photomask.

Next, for example, an application of a photosensitive conductive paste containing Ag as a main component is performed by screen printing or the like to form a new photosensitive conductive paste layer inside the via holes and the openings and also on the insulating paste layer already formed. Next, the photosensitive conductive paste layer is irradiated with ultraviolet rays or the like through a photomask and then developed with an alkaline solution or the like to form connecting conductor layers in the via holes and also form a new coil conductor layer connected to the connecting conductor layers on the insulating paste layer. Then, new outer conductor layers connected to the outer conductor layers already formed are formed in the openings, and newer outer conductor layers are formed on these outer conductor layers. The coil conductor layer, the connecting conductor layers, and the outer conductor layers are thus formed by the photolithography method. The connecting conductor layers formed in this process later serve as connecting conductors for connecting adjacent coil wiring lines in the coil axis direction.

Note that to form the coil conductor layer, the connecting conductor layers, and the outer conductor layers, for example, DI exposure which does not use a photomask may be performed instead of the exposure using a photomask.

After that, the process mentioned above is repeated to form insulating paste layers, coil conductor layers, connecting conductor layers, and outer conductor layers so that these layers will have a specified lamination structure. For example, the coil conductor layers formed in these processes include one that later serves as the second coil wiring 21b.

Note that when a coil conductor layer that later serves as the second coil wiring 21b and the outer conductor layers in the same layer as the coil conductor layer are formed, also an extended conductor layer connected to the coil conductor layer and an outer conductor layer is formed. The extended conductor layer formed in this process later serves as the second extended wiring 22b that connects the second coil wiring 21b and the second outer electrode 30b (specifically, the third electrode layer 31c).

Lastly, for example, an application of an insulating paste containing a glass material containing borosilicate glass as a main component is repeatedly performed by screen printing or the like to form new insulating paste layers. The insulating paste layers formed in this process include insulating paste layers that later serve as the insulation layer 15c and the insulation layer 15d.

A mother multilayer body is thus produced.

The method forming conductor patterns for the coil conductor layers, the extended conductor layers, the connecting conductor layers, and the outer conductor layers is not limited to the photolithography method mentioned above. For example, it may be a method of printing and laminating conductive paste, using a screen printing stencil having openings with a shape of conductor patterns, a method in which a conductor film is formed by sputtering, vapor deposition, a method of pressure-bonding foil, or the like, and then the conductor film is etched to be in the shape of conductor patterns, or a method in which a negative pattern is formed and then a plating film is formed by a semi-additive method, and unnecessary portions of the plating film are removed by etching or the like to form the shape of conductor patterns.

When the conductor patterns are formed for the coil conductor layers, the extended conductor layers, the connecting conductor layers, and the outer conductor layers, the conductor patterns are formed in multiple stages to achieve a high aspect ratio, and this reduces the loss due to resistance in high frequency. The method of forming conductor patterns in multiple stages is not particularly limited. For example, it may be a method in which a process using a photolithography method is repeated to overlay conductor patterns repeatedly as described above, a method in which conductor patterns formed by a semi-additive method are overlaid repeatedly, a method in which conductor patterns formed by a semi-additive method and conductor patterns formed by etching a plating film separately grown by plating are overlaid in random order, or a method in which a plating film formed by a semi-additive method is further grown by plating.

The conductive material composing the conductor patterns for the coil conductor layers, the extended conductor layers, the connecting conductor layers, and the outer conductor layers is not limited to a photosensitive conductive paste containing a metal as a main component such as a photosensitive conductive paste containing Ag as a main component as mentioned above. For example, it may be a conductor containing a metal such as Ag, Au, Cu, or the like, formed by sputtering, vapor deposition, a method of pressure-bonding foil, plating, or the like.

The method of forming the insulating paste layers is not limited to the photolithography method mentioned above. For example, it may be a method of pressure-bonding a sheet composed of an insulating material, a method of spin-coating an insulating material, or a method of spray-coating an insulating material.

The method of forming the insulating paste layers having via holes and openings is not limited to the photolithography method mentioned above. For example, it may be a method in which an insulating film is formed by a method such as pressure bonding a sheet composed of an insulating material, spin-coating an insulating material, spray-coating an insulating material, or the like, and then, via holes and openings are formed by performing laser processing, drilling, or the like on the insulating film.

The insulating material composing the insulating paste layers is not limited to a glass material containing borosilicate glass as a main component as mentioned above. For example, it may be a ceramic material; an organic material such as an epoxy resin, a fluororesin, and a polymer resin; a composite material such as a glass epoxy resin; or the like. For the insulating material, a material having low permittivity and low dielectric loss is particularly preferable.

<Process of Forming Element body, Coil, and Outer Electrodes>

First, the mother multilayer body is cut with a dicing machine or the like and separated into a plurality of unfired multilayer bodies

An unfired the multilayer body includes an insulating-paste multilayer portion in which insulating paste layers are laminated, a coil-conductor multilayer portion in which coil conductor layers are laminated such that adjacent coil conductor layer are electrically connected with a connecting conductor layer interposed between the adjacent layers, and outer-conductor multilayer portions in which outer conductor layers are laminated.

When individual unfired multilayer bodies are formed by the separation, the outer-conductor multilayer portions are exposed at two places on at least the bottom surface of the insulating-paste multilayer portion included in cut surfaces of an unfired multilayer body. The bottom surface of the insulating-paste multilayer portion later serves as the first main surface 12a of the element body 10.

Next, the unfired multilayer body is fired to produce a multilayer body.

Since the insulating paste layers become insulation layers when the unfired multilayer body is fired, the insulating-paste multilayer portion becomes the insulator included in the element body 10. Since the coil conductor layers become coil wiring when the unfired multilayer body is fired, the coil-conductor multilayer portion becomes the coil 20. In addition, when the unfired multilayer body is fired, one of the two outer-conductor multilayer portions becomes the first electrode layer 31a of the first outer electrode 30a, and the other becomes the third electrode layer 31c of the second outer electrode 30b.

Next, for example, barrel polishing may be performed on the obtained multilayer body to round the corners and the ridge lines of the element body 10.

Lastly, plating is performed on the first electrode layer 31a and the third electrode layer 31c, which are Ag base electrode layers, to form a Ni plating electrode layer and a Sn plating electrode layer in order on the surface of each Ag base electrode layer. One of the two Ni plating electrode layers formed in this process serves as the second electrode layer 31b of the first outer electrode 30a, and the other serves as the fourth electrode layer 31d of the second outer electrode 30b. One of the two Sn plating electrode layers formed in this process serves as another electrode layer of the first outer electrode 30a, different from the first electrode layer 31a and the second electrode layer 31b, and the other serves as another electrode layer of the second outer electrode 30b, different from the third electrode layer 31c and the fourth electrode layer 31d. The thickness of each of the Ni plating electrode layers and the Sn plating electrode layers is assumed to be, for example, 2 μm or more and 10 μm or less (i.e., from 2 μm to 10 μm).

The first outer electrode 30a and the second outer electrode 30b each including the Ag base electrode layer, the Ni plating electrode layer, and the Sn plating electrode layer in this order from the coil 20 side are thus formed.

The method of forming the outer electrodes is not limited to the method in which plating is performed on the outer-conductor multilayer portions exposed on cut surfaces (at least the bottom surface of the insulating-paste multilayer portion) of the unfired multilayer body as described above. For example, it may be a method in which the outer-conductor multilayer portions are exposed on cut surfaces (at least the bottom surface of the insulating-paste multilayer portion) of the unfired multilayer body as described above, and then, the exposed portions of the outer-conductor multilayer portions are immersed (dipped) in a conductive paste, or a method in which a film of a conductive paste is formed on the exposed portions of the outer-conductor multilayer portions by sputtering, and plating is performed on the film.

The inductor component 1A is thus manufactured.

In the inductor component 1A, as described above (see FIG. 2), the first main surface 12a has a recessed shape recessed toward the second main surface 12b such that the third point E3 is located closer to the second main surface 12b than the imaginary straight line F is, and that also the fourth point E4 is located closer to the second main surface 12b than is the imaginary straight line F. The method of recessing the first main surface 12a as described above is not particularly limited, and examples of the method include the following.

A first method is one in which part of the outer edge of each of the insulating paste layers having a lamination structure is formed to have a recessed shape in <Process of Producing Mother Multilayer Body>, so that the bottom surface of the insulating-paste multilayer portion has the recessed shape in an unfired multilayer body obtained from <Process of Forming Element Body, Coil, and Outer Electrodes>. After that, the unfired multilayer body in which the bottom surface of the insulating-paste multilayer portion has the shape is fired, so that the first main surface 12a of the obtained element body 10 has the recessed shape.

A second method is one in which polishing, laser processing, or the like is performed on the fired multilayer body in <Process of Forming Element Body, Coil, and Outer Electrodes>, so that the first main surface 12a of the element body 10 has a recessed shape.

The manufactured inductor component 1A has, for example, a 0402 (0.4 mm×0.2 mm×0.2 mm) size. The size of the inductor component 1A is not limited to the 0402 (0.4 mm×0.2 mm×0.2 mm) size.

The present specification discloses the following.

<1> An inductor component including an element body including an insulator; a coil located inside the element body; and a first outer electrode electrically connected to the coil. The element body includes a first end surface and a second end surface opposed to each other in a length direction, a first main surface and a second main surface opposed to each other in a height direction perpendicular to the length direction, and a first side surface and a second side surface opposed to each other in a width direction perpendicular to the length direction and the height direction. The first end surface intersects the first main surface on a first ridge line. The second end surface intersects the first main surface on a second ridge line. The first outer electrode includes a first electrode layer embedded in the element body such that at least part of the first electrode layer is exposed from the element body. The first electrode layer includes a portion extending from the first ridge line toward the second ridge line and exposed on the first main surface at a position away from the second ridge line and is not exposed on the second main surface. Also, when in a section parallel to the length direction and the height direction and including the first electrode layer, a first point corresponding to the first ridge line, a second point corresponding to the second ridge line, and a third point corresponding to a distal end, on a second-ridge-line side, of the portion of the first electrode layer located on the first main surface are defined, the third point is located closer to the second main surface than is an imaginary straight line connecting the first point and the second point.

<2> The inductor component according to <1>, in which a distance between the third point and the imaginary straight line in the height direction is 2 μm or more and 12 μm or less (i.e., from 2 μm to 12 μm).

<3> The inductor component according to <1> or <2>, in which a distance between the third point and the imaginary straight line in the height direction is 1% or more and 7% or less (i.e., from 1% to 7%) of a maximum dimension of the inductor component in the height direction.

<4> The inductor component according to any one of <1> to <3>, in which a distance between the third point and the second main surface in the height direction is less than a distance between the first point and the second main surface in the height direction.

<5> The inductor component according to any one of <1> to <4>, in which a minimum distance between the third point and a surface of the coil is 25 μm or less.

<6> The inductor component according to any one of <1> to <5>, in which the first electrode layer further includes a portion extending from the first main surface via the first ridge line to the first end surface and exposed on the first end surface.

<7> The inductor component according to any one of <1> to <6>, in which the first outer electrode further includes a second electrode layer located outside the element body and covering the first electrode layer.

<8> The inductor component according to any one of <1> to <7>, further including a second outer electrode located at a position away from the first outer electrode and electrically connected to the coil. The second outer electrode includes a third electrode layer embedded in the element body such that at least part of the third electrode layer is exposed from the element body. The third electrode layer includes a portion extending from the second ridge line toward the first ridge line and exposed on the first main surface at a position away from the first electrode layer and is not exposed on the second main surface. Also, when in a section parallel to the length direction and the height direction and including the first electrode layer and the third electrode layer, a fourth point corresponding to a distal end, on a first-ridge-line side, of the portion of the third electrode layer located on the first main surface is defined, the fourth point is located closer to the second main surface than is the imaginary straight line.

<9> The inductor component according to <8>, in which a distance between the fourth point and the imaginary straight line in the height direction is 2 μm or more and 12 μm or less (i.e., from 2 μm to 12 μm).

<10> The inductor component according to <8> or <9>, in which a distance between the fourth point and the imaginary straight line in the height direction is 1% or more and 7% or less (i.e., from 1% to 7%) of a maximum dimension of the inductor component in the height direction.

<11> The inductor component according to any one of <8> to <10>, in which a distance between the fourth point and the second main surface in the height direction is less than a distance between the second point and the second main surface in the height direction.

<12> The inductor component according to any one of <8> to <11>, in which a minimum distance between the fourth point and a surface of the coil is 25 μm or less.

<13> The inductor component according to any one of <8> to <12>, in which the third electrode layer further includes a portion extending from the first main surface via the second ridge line to the second end surface and exposed on the second end surface.

<14> The inductor component according to any one of <8> to <13>, in which the second outer electrode further includes a fourth electrode layer located outside the element body and covering the third electrode layer.

<15> The inductor component according to any one of <8> to <14>, in which the first main surface includes a flat portion located between the first outer electrode and the second outer electrode, and the second main surface is parallel to the flat portion of the first main surface.

What is claimed is:

1. An inductor component comprising:
an element body including an insulator;
a coil located inside the element body; and
a first outer electrode electrically connected to the coil, wherein
the element body includes a first end surface and a second end surface opposed to each other in a length direction, a first main surface and a second main surface opposed to each other in a height direction perpendicular to the length direction, and a first side surface and a second side surface opposed to each other in a width direction perpendicular to the length direction and the height direction,
the first end surface intersects the first main surface on a first ridge line,
the second end surface intersects the first main surface on a second ridge line,
the first outer electrode includes a first electrode layer embedded in the element body such that at least a portion of the first electrode layer is exposed from the element body,
the first electrode layer includes a portion thereof extending from the first ridge line toward the second ridge line and exposed on the first main surface at a position away from the second ridge line and not exposed on the second main surface, and
when in a section parallel to the length direction and the height direction and including the first electrode layer, a first point corresponding to the first ridge line, a second point corresponding to the second ridge line, and a third point corresponding to a distal end, on a second-ridge-line side, of the portion of the first electrode layer located on the first main surface are defined,
the third point is located closer to the second main surface than is an imaginary straight line connecting the first point and the second point.

2. The inductor component according to claim 1, wherein
a distance between the third point and the imaginary straight line in the height direction is from 2 μm to 12 μm.

3. The inductor component according to claim 1, wherein
a distance between the third point and the imaginary straight line in the height direction is from 1% to 7% of a maximum dimension of the inductor component in the height direction.

4. The inductor component according to claim 1, wherein
a distance between the third point and the second main surface in the height direction is less than a distance between the first point and the second main surface in the height direction.

5. The inductor component according to claim 1, wherein
a shortest distance between the third point and a surface of the coil is 25 μm or less.

6. The inductor component according to claim 1, wherein
the first electrode layer further includes a portion thereof extending from the first main surface via the first ridge line to the first end surface and exposed on the first end surface.

7. The inductor component according to claim 1, wherein
the first outer electrode further includes a second electrode layer covering the first electrode layer and located outside the element body.

8. The inductor component according to claim 1, further comprising
a second outer electrode located at a position away from the first outer electrode and electrically connected to the coil, wherein
the second outer electrode includes a third electrode layer embedded in the element body such that at least a portion of the third electrode layer is exposed from the element body,
the third electrode layer includes a portion thereof extending from the second ridge line toward the first ridge line and exposed on the first main surface at a position away from the first ridge line and not exposed on the second main surface, and
when in a section parallel to the length direction and the height direction and including the first electrode layer and the third electrode layer, a fourth point corresponding to a distal end, on a first-ridge-line side, of the portion of the third electrode layer located on the first main surface is defined,
the fourth point is located closer to the second main surface than is the imaginary straight line.

9. The inductor component according to claim 8, wherein
a distance between the fourth point and the imaginary straight line in the height direction is from 2 μm to 12 μm.

10. The inductor component according to claim 8, wherein
a distance between the fourth point and the imaginary straight line in the height direction is from 1% to 7% of a maximum dimension of the inductor component in the height direction.

11. The inductor component according to claim 8, wherein
a distance between the fourth point and the second main surface in the height direction is less than a distance between the second point and the second main surface in the height direction.

12. The inductor component according to claim 8, wherein
a shortest distance between the fourth point and a surface of the coil is 25 μm or less.

13. The inductor component according to claim 8, wherein
the third electrode layer further includes a portion thereof extending from the first main surface via the second ridge line to the second end surface and exposed on the second end surface.

14. The inductor component according to claim 8, wherein
the second outer electrode further includes a fourth electrode layer covering the third electrode layer and located outside the element body.

15. The inductor component according to claim 8, wherein
the first main surface includes a flat portion located between the first outer electrode and the second outer electrode, and
the second main surface is parallel to the flat portion of the first main surface.

16. The inductor component according to claim 2, further comprising
a second outer electrode located at a position away from the first outer electrode and electrically connected to the coil, wherein
the second outer electrode includes a third electrode layer embedded in the element body such that at least a portion of the third electrode layer is exposed from the element body,
the third electrode layer includes a portion thereof extending from the second ridge line toward the first ridge line and exposed on the first main surface at a position away from the first ridge line and not exposed on the second main surface, and
when in a section parallel to the length direction and the height direction and including the first electrode layer and the third electrode layer, a fourth point corresponding to a distal end, on a first-ridge-line side, of the portion of the third electrode layer located on the first main surface is defined,
the fourth point is located closer to the second main surface than is the imaginary straight line.

17. The inductor component according to claim 3, further comprising
a second outer electrode located at a position away from the first outer electrode and electrically connected to the coil, wherein
the second outer electrode includes a third electrode layer embedded in the element body such that at least a portion of the third electrode layer is exposed from the element body,
the third electrode layer includes a portion thereof extending from the second ridge line toward the first ridge line and exposed on the first main surface at a position away from the first ridge line and not exposed on the second main surface, and
when in a section parallel to the length direction and the height direction and including the first electrode layer and the third electrode layer, a fourth point corresponding to a distal end, on a first-ridge-line side, of the portion of the third electrode layer located on the first main surface is defined,
the fourth point is located closer to the second main surface than is the imaginary straight line.

18. The inductor component according to claim 4, further comprising
a second outer electrode located at a position away from the first outer electrode and electrically connected to the coil, wherein
the second outer electrode includes a third electrode layer embedded in the element body such that at least a portion of the third electrode layer is exposed from the element body,
the third electrode layer includes a portion thereof extending from the second ridge line toward the first ridge line and exposed on the first main surface at a position away from the first ridge line and not exposed on the second main surface, and
when in a section parallel to the length direction and the height direction and including the first electrode layer and the third electrode layer, a fourth point corresponding to a distal end, on a first-ridge-line side, of the portion of the third electrode layer located on the first main surface is defined,
the fourth point is located closer to the second main surface than is the imaginary straight line.

19. The inductor component according to claim 5, further comprising
a second outer electrode located at a position away from the first outer electrode and electrically connected to the coil, wherein
the second outer electrode includes a third electrode layer embedded in the element body such that at least a portion of the third electrode layer is exposed from the element body,
the third electrode layer includes a portion thereof extending from the second ridge line toward the first ridge line and exposed on the first main surface at a position away from the first ridge line and not exposed on the second main surface, and
when in a section parallel to the length direction and the height direction and including the first electrode layer and the third electrode layer, a fourth point corresponding to a distal end, on a first-ridge-line side, of the portion of the third electrode layer located on the first main surface is defined,
the fourth point is located closer to the second main surface than is the imaginary straight line.

20. The inductor component according to claim 6, further comprising
a second outer electrode located at a position away from the first outer electrode and electrically connected to the coil, wherein
the second outer electrode includes a third electrode layer embedded in the element body such that at least a portion of the third electrode layer is exposed from the element body,
the third electrode layer includes a portion thereof extending from the second ridge line toward the first ridge line and exposed on the first main surface at a position away from the first ridge line and not exposed on the second main surface, and
when in a section parallel to the length direction and the height direction and including the first electrode layer and the third electrode layer, a fourth point corresponding to a distal end, on a first-ridge-line side, of the portion of the third electrode layer located on the first main surface is defined,
the fourth point is located closer to the second main surface than is the imaginary straight line.
